(19) United States
(12) Patent Application Publication
(10) Pub. No.: US 2014/0028858 A1
(43) Pub. Date: Jan. 30, 2014

(54) Displays and Temperature Adaptive Display Calibration

(71) Applicants: Jiaying Wu, Santa Clara, CA (US); Gabriel Marcu, San Jose, CA (US); Ye Yin, Santa Clara, CA (US)

(72) Inventors: Jiaying Wu, Santa Clara, CA (US); Gabriel Marcu, San Jose, CA (US); Ye Yin, Santa Clara, CA (US)

(21) Appl. No.: 13/556,537

(22) Filed: Jul. 24, 2012

(51) Int. Cl. H04N 17/00

(52) U.S. Cl. 348/189; 348/E17.001

(57) ABSTRACT

A calibration system may be provided for calibrating displays in electronic devices during manufacturing. The calibration system may include calibration computing equipment and a test chamber having a light sensor. The calibration computing equipment may be configured to operate the light sensor and the display to gather display white point information such as the native white point of the display. Temperature data may be gathered from the electronic device during display calibration operations using a thermal sensor. The calibration computing equipment may determine a temperature adaptive target white point based on the gathered temperature data. The calibration computing equipment may be configured to compare the native white point of the display with the temperature adaptive target point. Based on the comparison, the calibration computing equipment may generate corresponding display calibration parameters. The display calibration parameters may be provided to and stored in the electronic device.

### BACKGROUND

This relates generally to display calibration, and, more particularly, to temperature adaptive display calibration.

Electronic devices such as portable computers, media players, cellular telephones, set-top boxes, and other electronic equipment are often provided with displays for displaying visual information.

Display color performance for a given display can be characterized by a native white point. The native white point of a display is commonly defined by a set of chromaticity values. The chromaticity values associated with the native white point are used to represent the color produced by the display when display pixels of all colors in the display are operating at full power.

Due to manufacturing variations, the native white point of one display may be different from the native white point of another display. Display color performance variations of this type can pose challenges when attempting to manufacture electronic devices having consistent display color performance.

To reduce color performance variation among device displays, displays are sometimes calibrated during manufacturing by adjusting the white point of each display. The white point of each display is typically adjusted to a fixed target white point with predetermined chromaticity values.

However, even after calibration, displays may still experience noticeable shifts in display white point. For example, rising temperatures in a display during operation of the display may induce noticeable shifts in the display white point.

It would therefore be desirable to be able to provide improved calibration systems for calibrating electronic devices with color displays.

### SUMMARY

An electronic device may be provided with a calibrated display. A display may be calibrated during manufacturing using a calibration system.

A display may include a liquid crystal display with display pixels configured to generate light of different colors. The display may be provided with display driver circuitry for operating the display pixels. The display driver circuitry may drive the display pixels at different power levels to generate light of a desired color.

A calibration system may include calibration computing equipment and a light sensor. The calibration computing equipment may operate the light sensor to gather display performance information such as a display white point information. Gathering display white point information may include measuring a native white point of the display.

Calibration computing equipment may gather temperature data from the electronic device using a thermal sensor. The thermal sensor may be included as an internal component in the electronic device or may be a separate component configured to measure a temperature of the electronic device. The temperature data gathered from the electronic device during calibration operations may be used to calibrate the display to compensate for temperature induced color shifts that may occur during operation of the display.

During calibration operations, calibration computing equipment may determine a temperature adaptive target white point for the display based on the temperature data gathered from the electronic device.

The temperature adaptive target white point may also be based on white point temperature dependence information. White point temperature dependence information may be based on data gathered from multiple electronic devices. For example, calibration computing equipment may be used to gather white point information and temperature data from multiple electronic devices. A relationship between display white point and device temperature may be extracted from the data. White point temperature dependence information may include, for example, the amount by which a chromaticity value changes for a given change in device temperature.

Calibration computing equipment may compare the native white point of the display with the temperature adaptive target white point. Based on the comparison, the calibration computing equipment may generate corresponding temperature adaptive display calibration parameters. The temperature adaptive display calibration parameters may be provided to and stored in the electronic device.

The temperature adaptive display calibration parameters may be stored in storage and processing circuitry in the electronic device. Display driver circuitry may provide display control signals to the display using the temperature adaptive display calibration parameters. The display calibration parameters may include one or more factors which are configured to adjust the intensity of light to be displayed by display pixels in the display.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of an illustrative electronic device such as a portable computer having a calibrated display in accordance with an embodiment of the present invention.

FIG. 2 is a diagram of an illustrative electronic device such as a cellular telephone or other handheld device having a calibrated display in accordance with an embodiment of the present invention.

FIG. 3 is a diagram of an illustrative electronic device such as a tablet computer having a calibrated display in accordance with an embodiment of the present invention.

FIG. 4 is a diagram of an illustrative electronic device such as a computer monitor with a built-in computer having a calibrated display in accordance with an embodiment of the present invention.

FIG. 5 is a diagram of an illustrative electronic device having a calibrated display in accordance with an embodiment of the present invention.

FIG. 6 is a diagram of an illustrative portion of a display showing how colored display pixels may be arranged in rows and columns in accordance with an embodiment of the present invention.

FIG. 7 is an illustrative chromaticity diagram showing how changes in temperature may induce display white point shifts in accordance with an embodiment of the present invention.

FIG. 8 is a diagram of an illustrative calibration system for performing display calibration including calibration computing equipment and a test chamber having a light sensor in accordance with an embodiment of the present invention.

FIG. 9 is a graph of illustrative white point temperature dependence information showing how a display white point tends to change for a given change in device temperature in accordance with an embodiment of the present invention.

FIG. 10 is a flow chart of illustrative steps involved in performing temperature adaptive display calibration in accordance with an embodiment of the present invention.

FIG. 11 is a flow chart of illustrative steps involved in obtaining white point temperature dependence information in accordance with an embodiment of the present invention.

FIG. 12 is a flow chart of illustrative steps involved in performing display calibration using a temperature adaptive target white point in accordance with an embodiment of the present invention.

FIG. 13 is a flow chart of illustrative steps involved in performing validation operations to verify the color performance of a display after calibration in accordance with an embodiment of the present invention.

### DETAILED DESCRIPTION

Electronic devices such as cellular telephones, media players, computers, set-top boxes, wireless access points, and other electronic equipment may include calibrated displays. Displays may be used to present visual information and status data and/or gather user input data.

Display color performance may be characterized in part by color performance statistics such as a display white point. The display white point of a given display may be measured and modified to be close to a target white point during calibration operations. The target white point may be temperature adaptive. Temperature information may be gathered from a device during calibration operations and may be used to generate temperature adaptive display calibration parameters. The temperature adaptive display calibration parameters may be stored in the electronic device.

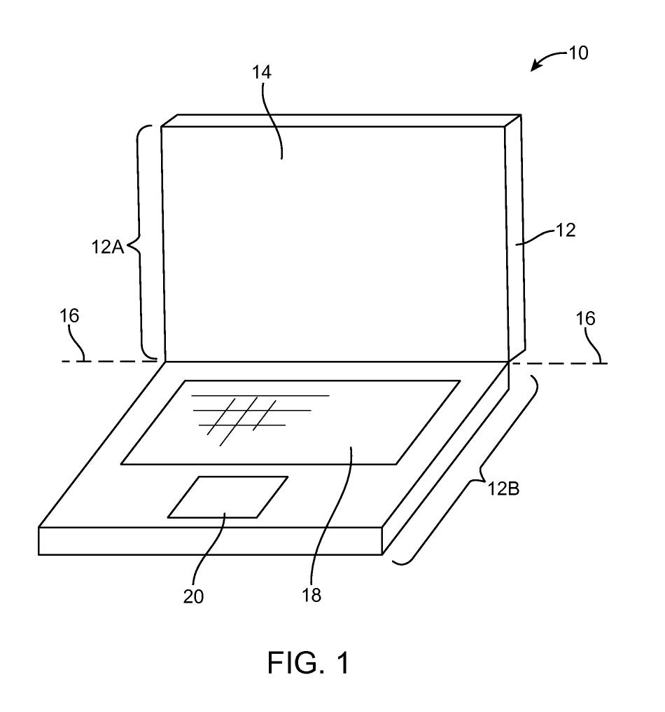

An illustrative electronic device of the type that may be provided with a display is shown in FIG. 1. Electronic device 10 may be a computer such as a computer that is integrated into a display such as a computer monitor, a laptop computer, a tablet computer, a somewhat smaller portable device such as a wrist-watch device, pendant device, or other wearable or miniature device, a cellular telephone, a media player, a tablet computer, a gaming device, a navigation device, a computer monitor, a television, or other electronic equipment.

As shown in FIG. 1, device 10 may include a display such as display 14. Display 14 may be a touch screen that incorporates capacitive touch electrodes or other touch sensor components or may be a display that is not touch-sensitive. Display 14 may include display pixels formed from light-emitting diodes (LEDs), organic light-emitting diodes (OLEDs), plasma cells, electrophoretic display elements, electrowetting display elements, liquid crystal display (LCD) components, or other suitable image pixel structures. Arrangements in which display 14 is formed using liquid crystal display pixels are sometimes described herein as an example. This is, however, merely illustrative. Any suitable type of display technology may be used in forming display 14 if desired. If desired, display 14 may include a cover layer such as a layer of glass (e.g., a display cover glass) that covers the front of display 14.

Device 10 may have a housing such as housing 12. Housing 12, which may sometimes be referred to as a case, may be formed of plastic, glass, ceramics, fiber composites, metal (e.g., stainless steel, aluminum, etc.), other suitable materials, or a combination of any two or more of these materials.

Housing 12 may be formed using a unibody configuration in which some or all of housing 12 is machined or molded as a single structure or may be formed using multiple structures (e.g., an internal frame structure, one or more structures that form exterior housing surfaces, etc.).

As shown in FIG. 1, housing 12 may have multiple parts. For example, housing 12 may have upper portion 12A and lower portion 12B. Upper portion 12A may be coupled to lower portion 12B using a hinge that allows portion 12A to rotate about rotational axis 16 relative to portion 12B. A keyboard such as keyboard 18 and a touch pad such as touch pad 20 may be mounted in housing portion 12B.

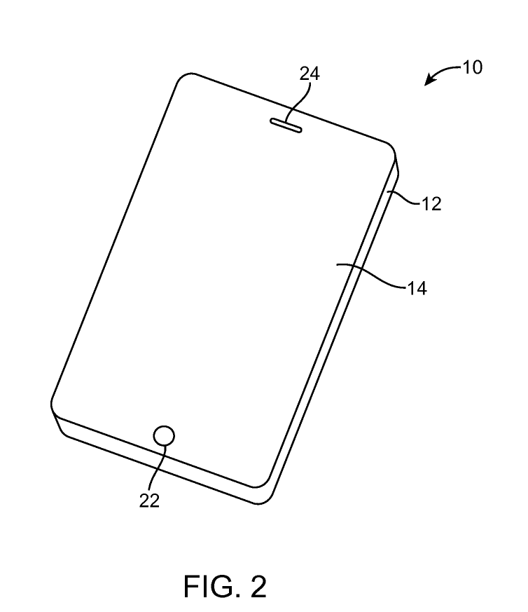

In the example of FIG. 2, device 10 has been implemented using a housing that is sufficiently small to fit within a user's hand (i.e., device 10 of FIG. 2 may be a handheld electronic device such as a cellular telephone). As show in FIG. 2, device 10 may include a display such as display 14 mounted on the front of housing 12. Display 14 may be substantially filled with active display pixels or may have an active portion and an inactive portion. Display 14 may have openings (e.g., openings in the inactive or active portions of display 14) such as an opening to accommodate button 22 and an opening to accommodate speaker port 24.

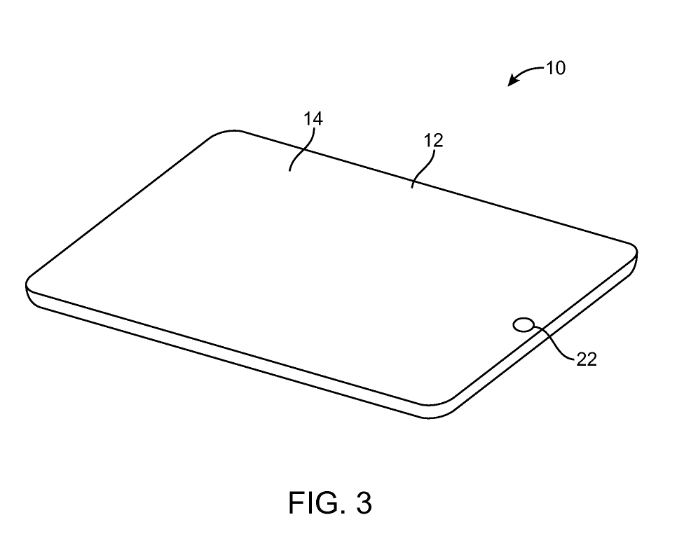

FIG. 3 is a perspective view of electronic device 10 in a configuration in which electronic device 10 has been implemented in the form of a tablet computer. As shown in FIG. 3, display 14 may be mounted on the upper (front) surface of housing 12. An opening may be formed in display 14 to accommodate button 22.

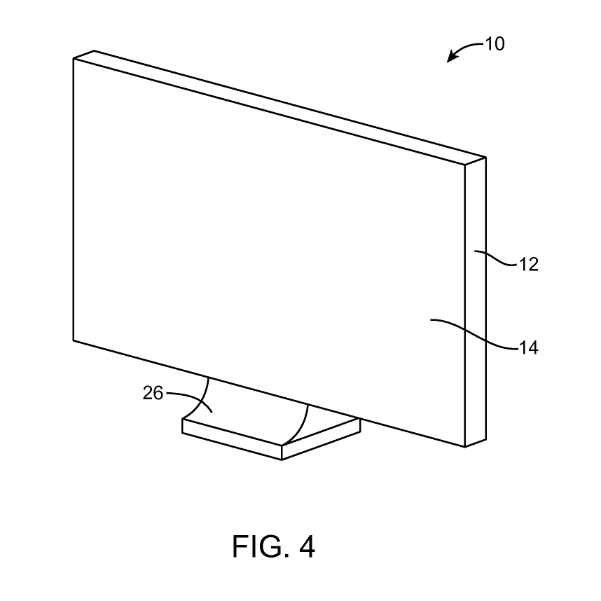

FIG. 4 is a perspective view of electronic device 10 in a configuration in which electronic device 10 has been implemented in the form of a computer integrated into a computer monitor. As shown in FIG. 4, display 14 may be mounted on the front surface of housing 12. Stand 26 may be used to support housing 12.

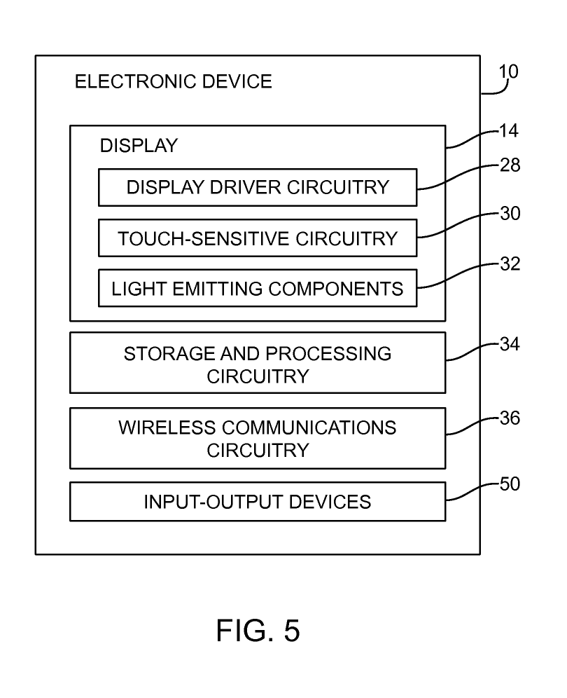

A diagram of electronic device 10 is shown in FIG. 5. As shown in FIG. 5, electronic device 10 may include a display such as display 14. Display 14 may include light-emitting components 32, touch-sensitive circuitry 30, display driver circuitry 28 for operating light-emitting components 32, and other display components.

Light-emitting components 32 may include display pixels formed from reflective components, liquid crystal display (LCD) components, organic light-emitting diode (OLED) components, or other suitable display pixel structures. To provide display 14 with the ability to display color images, light-emitting components 32 may include display pixels having color filter elements. Each color filter element may be used to impart color to the light associated with a respective display pixel in the pixel array of display 14.

Display touch circuitry such as touch-sensitive circuitry 30 may include capacitive touch electrodes (e.g., indium tin oxide electrodes or other suitable transparent electrodes) or other touch sensor components (e.g., resistive touch technologies, acoustic touch technologies, touch sensor arrangements using light sensors, force sensors, etc.). Display 14 may be a touch screen that incorporates display touch circuitry 30 or may be a display that is not touch sensitive.

Display driver circuitry 28 may be implemented using one or more integrated circuits (ICs) and may sometimes be referred to as a driver IC, display driver integrated circuit, or display driver. Display driver circuitry 28 may include, for example, timing controller (ICON) circuitry such as a ICON integrated circuit. Display driver circuitry 28 may, for example, be mounted on an edge of a thin-film-transistor substrate layer in display 14 (as an example). Display driver circuitry 28 may be coupled to additional circuitry in device 10 such as storage and processing circuitry 34.

Control circuitry such as storage and processing circuitry 34 in device 10 may include microprocessors, microcontrollers, digital signal processor integrated circuits, application-specific integrated circuits, and other processing circuitry. Volatile and non-volatile memory circuits such as random-access memory, read-only memory, hard disk drive storage, solid state drives, and other storage circuitry may also be included in circuitry 34. Circuitry 34 may include storage configured to store boot information to be used during boot operations for the device. Display calibration information may be stored as part of the boot information or may be stored using display driver circuitry 28 or other circuitry associated with display 14.

Circuitry 34 may use wireless communications circuitry 36 and/or input-output devices 50 to obtain user input and to provide output to a user. Input-output devices 50 may include speakers, microphones, sensors, buttons, keyboards, displays, touch sensors, and other components for receiving input and supplying output. Wireless communications circuitry 36 may include wireless local area network transceiver circuitry, cellular telephone network transceiver circuitry, and other components for wireless communication.

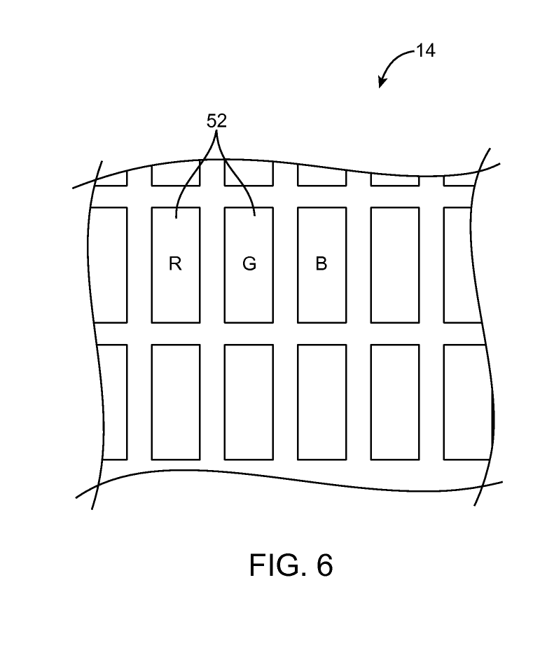

Display 14 may include an array of display pixels. Each display pixel may be used to generate display light associated with a portion of the display. A portion of an illustrative array of display pixels is shown in FIG. 6. As shown in FIG. 6, display 14 may have a pixel array with rows and columns of pixels such as display pixels 52. There may be tens, hundreds, or thousands of rows and columns of display pixels 52. Each pixel 52 may, if desired, be a color pixel such as a red (R) pixel, a green (G) pixel, a blue (B) pixel or a pixel of another color. Red pixels R, for example, may include a red color filter element over a light generating element (e.g., a liquid crystal pixel element or an OLED pixel element) that absorbs and/or reflects non-red light while passing red light. This is, however, merely illustrative. Pixels 52 may include any suitable structures for generating light of a given color.

Pixels 52 may include pixels of any suitable color. For example, pixels 52 may include a pattern of cyan, magenta, and yellow pixels, or may include any other suitable pattern of colors. Arrangements in which pixels 52 include a pattern of red, green, and blue pixels is sometimes described herein as an example.

Display driver circuitry 28 (FIG. 5) such as a display driver integrated circuit and, if desired, associated thin-film transistor circuitry formed on a display substrate layer may be used to produce signals such as data signals and gate line signals (e.g., on data lines and gate lines respectively in display 14) for operating pixels 52 (e.g., turning pixels 52 on and/or off and/or adjusting the intensity of pixels 52). During operation, display driver circuitry 28 may control the values of the data signals and gate signals to control the light intensity associated with each of the display pixels and thereby display images on display 14.

Display driver circuitry 28 may be used to convert digital display control values for each display pixel 52 into analog display signals for controlling the brightness of each pixel. Control circuitry such as storage and processing circuitry 34 may provide digital display control values (commonly integers with values ranging from 0 to 255) corresponding to the desired pixel intensity of each pixel to display driver circuitry 28. For example, a digital display control value of 0 may result in an “off” pixel, whereas a digital display control value of 255 may result in a pixel operating at a maximum available power.

Digital display control values may include any suitable range of values. For example, digital display control values may be a set of integers ranging from 0 to 64. Arrangements in which digital display control values include integer values ranging from 0 to 255 is sometimes described herein as an example.

Display driver circuitry 28 may be used to concurrently operate pixels 52 of different colors in order to generate light having a color that is a mixture of, for example, primary colors red, green, and blue. As examples, operating red pixels R and blue pixels B may produce light that appears violet, operating red pixels R and green pixels G may generate light that appears yellow, and operating red pixels R, green pixels G, and blue pixels B may generate light that appears white.

However, light that appears white to a human eye may include different underlying spectral power distributions (e.g., may be generated from various combinations of light of individual colors such as red light, green light, and blue light). As examples, sunlight appears white to the human eye, but includes a relatively large amount of blue light, whereas light from an incandescent light bulb appears white to the human eye but includes a relatively large amount of red light.

Due to manufacturing variations, some displays operating at full power may have different underlying spectral power distributions than other displays operating at full power. Due to these manufacturing differences, the white light produced by a display in one device may differ from the white light produced by a display in another device.

These differences may be corrected by adjusting the display control settings of the display in one device so that the display color performance of that display matches the display color performance of a display in another device. Adjusting the display control settings of a display may include, for example, adjusting the relative maximum power levels that display control circuitry such as circuitry 28 (FIG. 5) delivers to pixels 52 of each color. Maximum power levels for pixels 52 of a given color may be reduced, for example, by reducing the maximum possible digital display control value for the pixels of that color (e.g., from a maximum value of 255 to a maximum value of 251).

In order to produce electronic devices with displays that exhibit uniform display color performance across all devices, the display in each device may be calibrated during manufacturing so that the display color performance (e.g., the spectral content of white light) of the display in each device matches a standard (sometimes called a target) display color performance.

Display color performance of a display such as display 14 may be characterized by color performance statistics such as the “white point” of the display. The white point of a given display is commonly defined by a set of chromaticity values that encode the spectral content of light produced by the display when the display is operating all display pixels of all colors at full power. Prior to any corrections during calibration, the white point of a display is sometimes referred to as the “native white point” (NWP) of the display.

The color performance of a display prior to calibration (e.g., the native white point of a display) may differ from desired (target) color performance. Desired color performance of a display may be characterized by a “target white point” (TWP). A target white point may be represented by a set of chromaticity values that encode the spectral content of standard white light (e.g., the spectral content of white light generated by a reference display, the spectral content of a standard illuminant, etc.). For example, a target white point TWP may be a set of chromaticity values corresponding to the standard illuminant D65 as defined by the International Commission on Illumination (CIE). This is, however, merely illustrative. A target white point may be defined in any suitable manner.

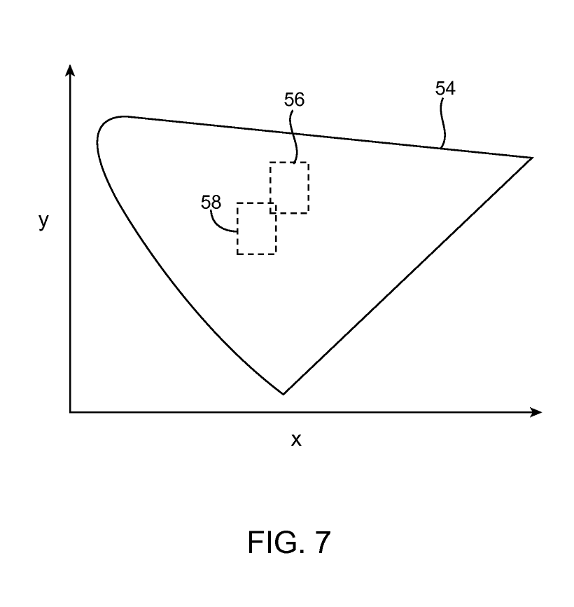

Displays are sometimes calibrated during manufacturing so that the white point of each display falls within a desired range of a common target white point. However, even after this type of calibration, the white point of a display may still be noticeably different from that of another display due to temperature induced white point shifts. For example, the white point of a display may shift outside of the desired range of the common target white point as the temperature of the display increases. A chromaticity diagram illustrating this type of temperature induced white point shift is shown in FIG. 7.

The chromaticity diagram of FIG. 7 represents a two-dimensional projection of a three-dimensional color space. The color generated by a display such as display 14 may be represented by the chromaticity values x and y. The chromaticity values may be computed by transforming, for example, three color intensities (e.g., intensities of colored light emitted by a display) such as intensity of red light, intensity of green light, and intensity of blue light into three tristimulus values X, Y, and Z and normalizing the first two tristimulus values X and Y (e.g., by computing x=X/(X+Y+Z) and y=Y/(X+Y+Z) to obtain normalized x and y values). Transforming color intensities into tristimulus values may be performed using transformations defined by the International Commission on Illumination (CIE) or using any other suitable color transformation for computing tristimulus values.

Any color generated by a display such as display 14 may therefore be represented by a point (e.g., by chromaticity values x and y) on a chromaticity diagram such as the diagram shown in FIG. 7. Bounded region 54 of FIG. 7 represents the chromaticity values of all combinations of colors (i.e., the total available color space). The colors that may be generated by a display are contained within a sub-region of bounded region 54.

Displays are sometimes calibrated such that the white point of each display falls within a desired range of a common target white point. For example, displays may be calibrated such that the white point of each display lies within bounded region 56. However, operating conditions such as increasing device temperature may cause the white point of a display to shift towards bounded region 58. A white point that lies in bounded region 58 may have a higher content of blue light than a white point that lies in bounded region 56.

Various factors may contribute to a temperature induced white point shift. For example, the wavelength of light produced by light-emitting diodes (e.g., light-emitting diodes that form a backlight for a display) may be temperature dependent. The refractive index of liquid crystal material may also be temperature dependent. These temperature dependent properties play an important role in the perceived white point of a display. Conventional methods of white point calibration do not account for the white point shift that can occur as a device experiences changes in temperature.

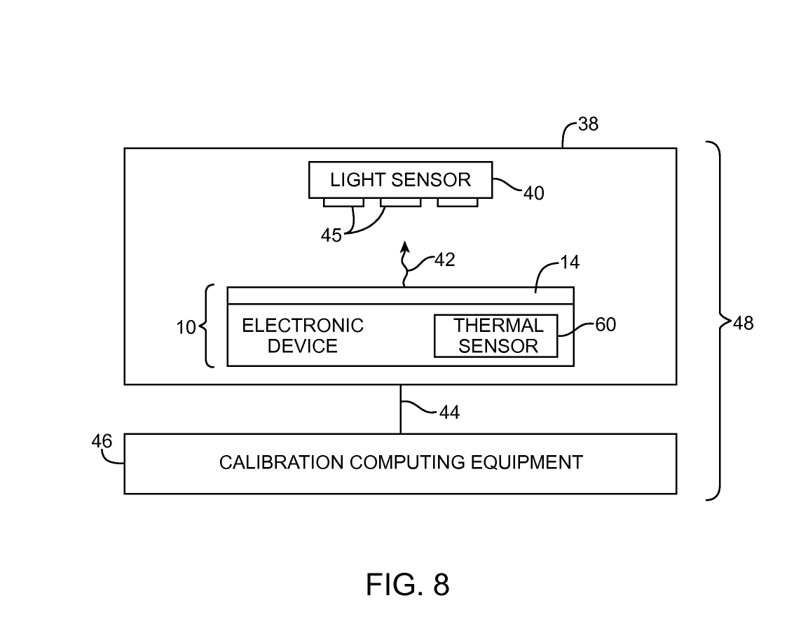

FIG. 8 is a diagram of an illustrative calibration system that may be used to perform temperature adaptive display calibration on a display such as display 14 of device 10. As shown in FIG. 8, calibration system 48 may include calibration computing equipment 46 that is coupled to test apparatus such as test chamber 38. Calibration computing equipment 46 may include one or more computers, one or more databases, one or more displays, one or more technician interface devices (e.g., keyboards, touch-screens, joysticks, buttons, switches, etc.) for technician control of calibration computing equipment 46, communications components or other suitable calibration computing equipment.

Calibration computing equipment 46 may be coupled to test chamber 38 using a wired or wireless communications path such as path 44.

Test chamber 38 may include a light sensor such as light sensor 40. Light sensor 40 may include one or more light-sensitive components such as light-sensitive components 45 for gathering display light 42 emitted by display 14 during calibration operations. Light-sensitive components 45 may include, for example, colorimetric light-sensitive components and/or spectrophotometric light-sensitive components that are configured to gather colored light from display 14.

Light sensor 40 may, for example, be a colorimeter having one or more light-sensitive components 45 corresponding to each set of colored pixels in display 14. For example, a display having red, green, and blue display pixels may be calibrated using a light sensor having corresponding red, green, and blue light-sensitive components 45. This is, however, merely illustrative. A display may include display pixels for emitting colors other than red, green, and blue, and light sensor 40 may include light-sensitive components 45 sensitive to colors other than red, green, and blue, may include white light sensors, or may include spectroscopic sensors.

Test chamber 38 may, if desired, be a light-tight chamber that prevents outside light (e.g., ambient light in a testing facility) from reaching light sensor 40 during calibration operations.

During calibration operations, calibration computing equipment 46 may gather information from device 10 such as temperature information and display performance information. Calibration computing equipment 46 may use the temperature information and display performance information gathered from device 10 to generate temperature adaptive display calibration parameters for device 10.

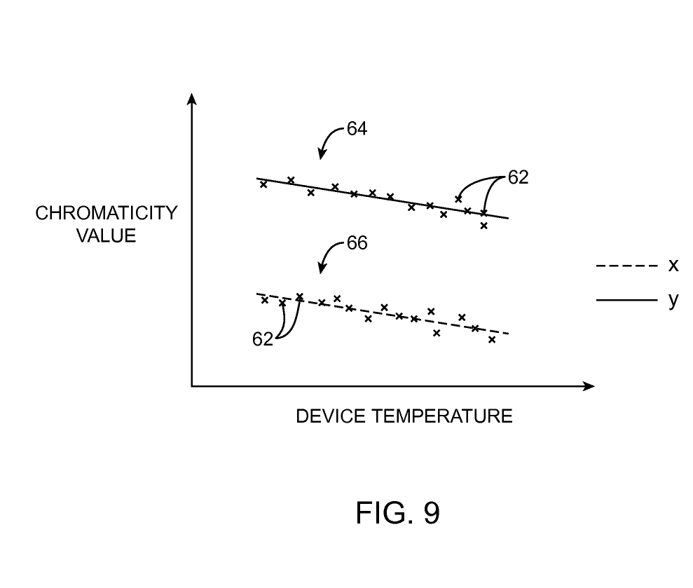

Temperature information may be gathered from device 10 using a thermal sensor such as thermal sensor 60. Thermal sensor 60 may be an internal sensor in device 10 (as shown in FIG. 9) or may be external sensor such as an infrared thermal gun or other suitable type of temperature sensor. Thermal sensor 60 may be used to measure any suitable temperature associated with device 10. For example, thermal sensor 60 may be configured to measure display cover glass temperature (e.g., the temperature associated with a cover glass layer that covers display 14), backlight temperature (e.g., the temperature associated with light-emitting diodes in a backlight for display 14), internal component temperature (e.g., the temperature associated with an internal component in device 10 such as a central processing unit (CPU) or other component), etc. “Device temperature” may sometimes be used herein to describe any suitable temperature associated with device 10.

Temperature information gathered by thermal sensor 60 may be provided to calibration computing equipment 46 via path 44. Calibration computing equipment 46 may use the gathered temperature information to determine a temperature dependent target white point for display 14.

Display performance information may include display white point information. For example, light sensor 40 may gather white point information from display 14 by measuring the intensities of colored light (e.g., by measuring the intensities of red, green, and blue light) emitted from display 14 while all of the pixels of display 14 are operated at full power. Display performance information gathered by light sensor 40 may be provided to calibration computing equipment 46 via path 44. Calibration computing equipment 46 may determine the measured white point of display 14 by transforming the measured intensities of red, green, and blue light into tristimulus values X, Y, and Z and subsequently mapping the tristimulus values to chromaticity values x and y. Calibration computing equipment 46 may compare the measured white point of display 14 with a temperature dependent target white point.

During calibration operations, device 10 may be placed into test chamber 38 (e.g., by a technician or by a robotic member). Calibration computing equipment 46 may be used to operate device 10 and light sensor 40 during calibration operations. For example, calibration computing equipment 46 may issue a command (e.g., by transmitting a signal over path 44) to device 10 to operate some or all pixels of display 14. While device 10 is operating the pixels of display 14, calibration computing equipment 46 may operate light sensor 40 to gather display performance information from display 14 corresponding to the light 42 emitted by display 14. When it is desired to read out one or more temperatures associated with device 10, calibration computing equipment 46 may issue a command to device 10 to supply a temperature reading from thermal sensor 60 to calibration computing equipment 46 over path 44. In configurations where thermal sensor 60 is separate from device 10, calibration computing equipment 46 may, if desired, request a temperature reading directly from sensor 60.

Calibration computing equipment 46 may determine a temperature adaptive target white point for display 14 using the temperature information gathered from device 10 during calibration operations and by using white point temperature dependence information. White point temperature dependence information may include, for example, the amount by which a display white point tends to change for a given change in device temperature. The relationship between display white point and temperature may be used in determining a temperature adaptive target white point for each display. In this way, the temperature adaptive target white point may compensate for the temperature induced white point shift that tends to occur during operation of a device.

FIG. 9 is an illustrative graph showing how display white point temperature dependence information may be extracted from gathered display white point information and temperature data. During calibration operations, calibration computing equipment 46 may gather data such as data 62 from a display. Each data point 62 may correspond to the native white point (e.g., the native white point (NWP) as represented by chromaticity values x and y) of a display at a given temperature. For simplicity, only the data points corresponding to data gathered from a single display are shown in FIG. 9. However, if desired, display white point temperature dependence information may gathered from a sample size of multiple devices (e.g., five devices, ten devices, fifty devices, more than fifty devices, less than fifty devices, etc.) and may be used in calibrating all or substantially all devices. In another suitable embodiment, display white point temperature dependence information may be gathered for each display individually prior to calibration (if desired).

Display white point temperature dependence information may be determined by fitting a curve to gathered data 62 (e.g., using a linear regression process or any other suitable data fitting process). For example, as shown in FIG. 9, lines 64 and 66 may be determined to fit data 62. Display white point temperature dependence information may include, for example, the amount by which NWP chromaticity value x changes for a given change in temperature (e.g., slope μₓ of line 66) and the amount by which NWP chromaticity value y changes for a given change in temperature (e.g., slope μ_{y} of line 64).

As described above, white point temperature dependence information such as x dependence μₓ and y dependence μ_{y} may be determined on a per-device basis (e.g., by directly measuring white point temperature dependence information for each device) or may be predetermined using a sample size of multiple devices. For example, it may be determined (using a sample size of multiple devices or for a single device) that NWP chromaticity value x decreases by 0.005 for every 10° C. increase in device temperature (as an example).

Predetermined white point temperature dependence information such as x dependence μₓ and y dependence μ_{y} may be used in combination with temperature data gathered from each device to determine a temperature adaptive target white point for each device. This is, however, merely illustrative. If desired, a temperature adaptive target white point may be determined based on temperature data gathered form device 10 only, or may be determined based on white point temperature dependence information only.

In order to determine a temperature adaptive target white point for each device that will result in uniform display color performance across all devices, the temperature adaptive target white point may be based on a reference target white point (x₀, y₀) at a reference temperature T₀. The reference target white point may be defined in any suitable manner. For example, the reference target white point may be the standard illuminant D65 or other predetermined white point. The reference temperature may be any suitable predetermined temperature. For example, the reference temperature may be equal to an average temperature which devices reach at a given point time (e.g., average device temperature during boot-up operations, average device temperature one minute after boot-up operations, average device temperature five minutes after boot-up operations, etc.). This is, however, merely illustrative. In general, the reference target white point (x₀, y₀) and corresponding reference temperature T₀ may be defined in any suitable manner.

During calibration operations, calibration computing equipment 46 may obtain temperature data from device 10 using thermal sensor 60 (FIG. 8). Based on the gathered temperature data, calibration computing equipment 46 may determine a temperature adaptive target white point. An illustrative algorithm that may be used to determine a temperature adaptive target white point is shown below:

xₜ=x₀+(T−T₀)μₓ (1)

yₜ=y₀+(T−T₀)μ_{y} (2)

where (xₜ, yₜ) is the temperature adaptive target white point, (x₀, y₀) is the reference target white point, T is the device temperature read out from thermal sensor 60, T₀ is the reference temperature, μₓ represents the temperature dependence of the NWP chromaticity value x (e.g., μₓ may be equal to the slope of line 66), and μ_{y} represents the temperature dependence of the NWP chromaticity value y (e.g., μ_{y} may be equal to the slope of line 64).

By determining a temperature adaptive target white point for each device using temperature data gathered from each device, displays may exhibit uniform color performance even after temperature induced white point shifts.

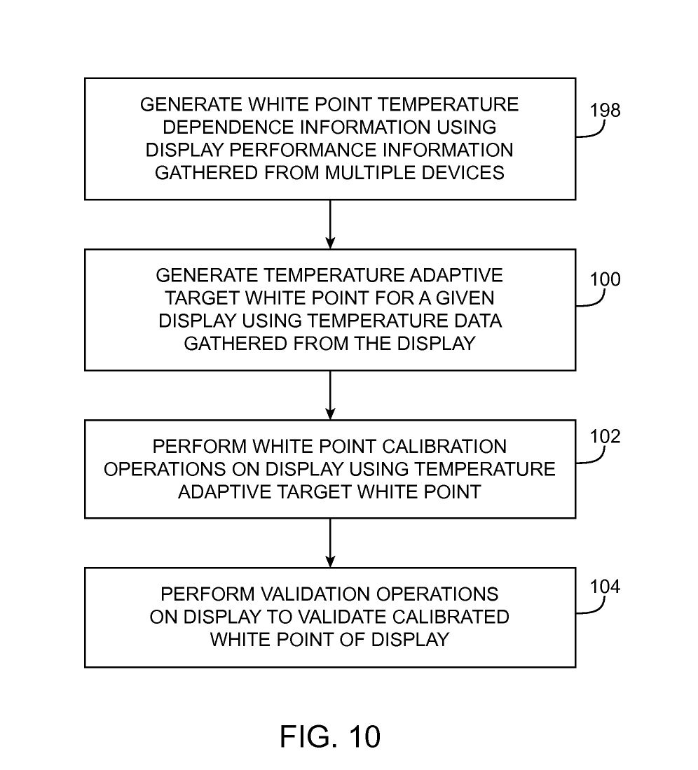

FIG. 10 is a flow chart of illustrative steps involved in performing temperature adaptive display calibration.

At step 198, calibration computing equipment 46 may generate white point temperature dependence information using display performance information gathered from multiple devices. For example, calibration computing equipment 46 may determine how the native white point of a display tends to change for a given change in device temperature. This may include, for example, determining x dependence μₓ and y dependence μ_{y} as described in connection with FIG. 9. If desired, white point temperature dependence information may be based on data gathered from multiple devices. With this type of configuration, white point temperature dependence information gathered during step 198 may be used for calibration of all devices. This is, however, merely illustrative. If desired, white point temperature dependence information may be gathered for each device prior to calibration.

At step 100, calibration computing equipment 46 may generate a temperature adaptive target white point for a given display such as display 14 of device 10. The temperature adaptive white point may be based on temperature data gathered from device 10 during calibration operations. The temperature adaptive white point may also be based on the white point temperature dependence information (e.g., predetermined white point temperature dependence information) generated during step 198.

At step 102, calibration computing equipment 46 may perform calibration operations on display 14 using the temperature adaptive target white point generated in step 100. This may include comparing the native white point of display 14 with the temperature adaptive target white point. Based on the comparison, calibration computing equipment 46 may generate corresponding display calibration parameters. The display calibration parameters may subsequently be transferred to device 10.

At step 104, calibration computing equipment 46 may perform validation operations to assess the performance of the calibrated display. For example, calibration computing equipment 46 may gather additional temperature data and display white point information from device 10. Calibration computing equipment 46 may determine whether the calibrated white point of display 14 is satisfactory based on the additional temperature data and display white point information.

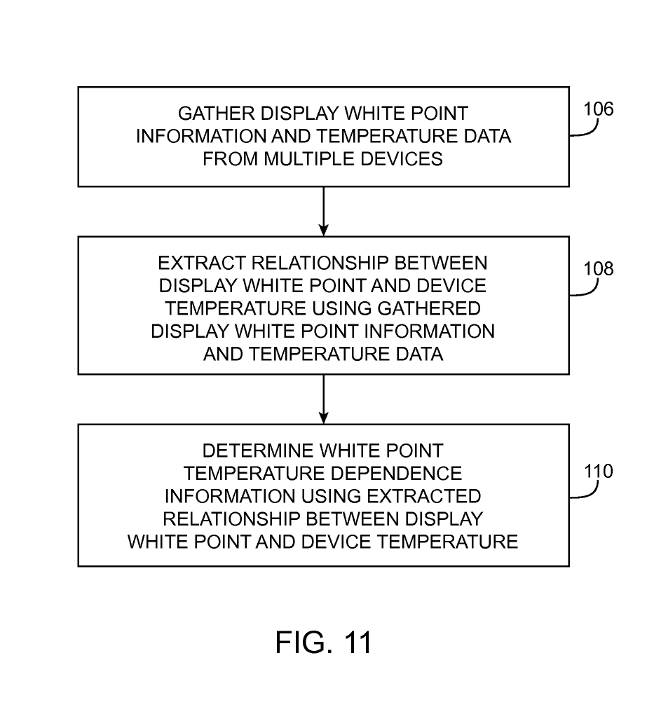

FIG. 11 is a flow chart of illustrative steps involved in generating white point temperature dependence information (as described in step 198 of FIG. 10).

At step 106, calibration computing equipment 46 may be used to gather display white point information (e.g., native white point information) and temperature data from multiple devices. This may include gathering data such as data 62 of FIG. 9 from multiple devices using calibration system 48 of FIG. 8. Gathering data 62 may include, for example, measuring the native white point of a display using light sensor 40 and obtaining a corresponding device temperature from thermal sensor 60. For each device from which data is gathered during step 106, calibration computing equipment 46 may measure the native white point at a range of device temperatures.

At step 108, calibration computing equipment 46 may be used to extract the relationship between display white point and device temperature using the data gathered during step 106. This may include, for example, compiling data such as data 62 gathered during step 106 and fitting a curve to the gathered data to extract the relationship between native white point and device temperature.

At step 110, calibration computing equipment 46 may be used to determine white point temperature dependence information based on the extracted relationship between native white point and device temperature. This may include, for example, determining the temperature dependence μₓ of native white point chromaticity value x and the temperature dependence μ_{y} of native white point chromaticity value y.

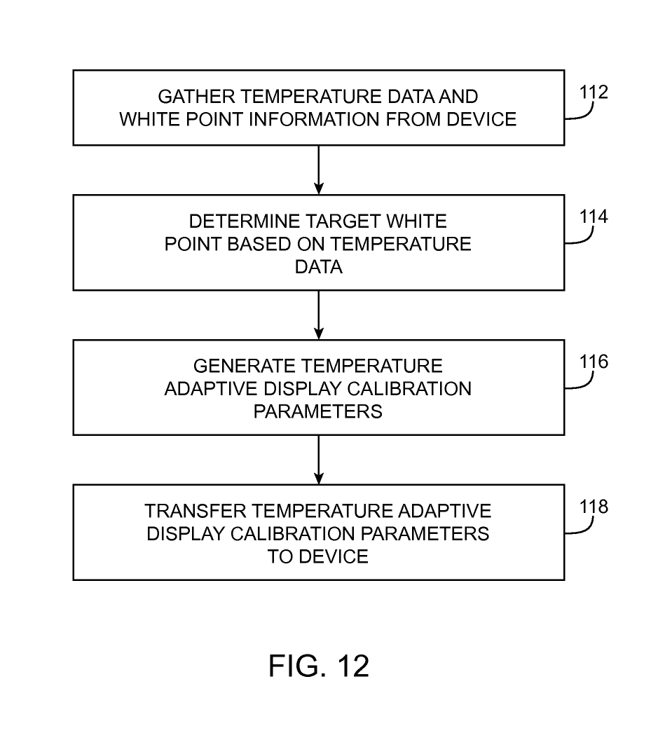

FIG. 12 is a flow chart of illustrative steps involved in performing display calibration on a display such as display 14 using a temperature adaptive target white point (as described in steps 100 and 102 of FIG. 10).

At step 112, calibration computing equipment 46 may gather temperature data and white point information from device 10. For example, light sensor 40 may be used to measure the native white point of display 14 while calibration computing equipment 46 obtains a device temperature reading from thermal sensor 60. Temperature data gathered during step 112 may include display cover glass temperature, backlight temperature, CPU temperature, and/or any other suitable temperature associated with device 10. If desired, temperature data may be gathered during boot-up operations, one minute after boot-up operations, five minutes after boot-up operations, and/or at other suitable times.

At step 114, calibration computing equipment 46 may use the temperature data gathered during step 112 to determine a temperature adaptive target white point for display 14. This may include, for example, using equations (1) and (2) to determine a temperature adaptive target white point (xₜ, yₜ). If equations (1) and (2) are used to determine a temperature adaptive target white point, T may be equal to the temperature reading obtained during step 112, and μₓ and μ_{y} may be based on the temperature dependence information gathered during step 110 of FIG. 11 (e.g., μₓ may be equal to the slope of line 66, and μ_{y} may be equal to the slope of line 64). The use of equations (1) and (2) to determine a temperature adaptive target white point for display 14 is merely illustrative. If desired, other suitable methods may be used to determine a temperature adaptive target white point based on temperature data gathered from device 10.

At step 116, calibration computing equipment 46 may generate temperature adaptive display calibration parameters for device 10. This may include comparing the native white point of display 14 (measured in step 112) with the temperature adaptive target white point (determined in step 114). For example, calibration computing equipment 46 may determine if the native white point of display 14 is within an acceptable predetermined range of the temperature adaptive target white point. Calibration computing equipment 46 may generate corresponding display calibration parameters based on the comparison between the native white point and the temperature adaptive target white point. Display calibration parameters may include, for example, multiplicative factors for scaling the relative power level provided to the display pixels of each color in display 14 or may include other calibration parameters such as constant multiplicative values, time-dependent values, power-level-dependent values, and/or other adaptive parameters for adjusting the color performance of display 14.

At step 118, calibration computing equipment 46 may transfer the temperature adaptive display calibration parameters to device 10. Calibration parameters uploaded from calibration computing equipment 46 to device 10 during calibration operations may be stored on device 10 using storage and processing circuitry 34 (FIG. 5). Uploading display calibration parameters from calibration computing equipment 46 to device 10 may include storing the calibration data in volatile or non-volatile memory for access by software running on circuitry 34 and/or hard coding calibration data into firmware associated with display 14 (e.g., display driver circuitry 28).

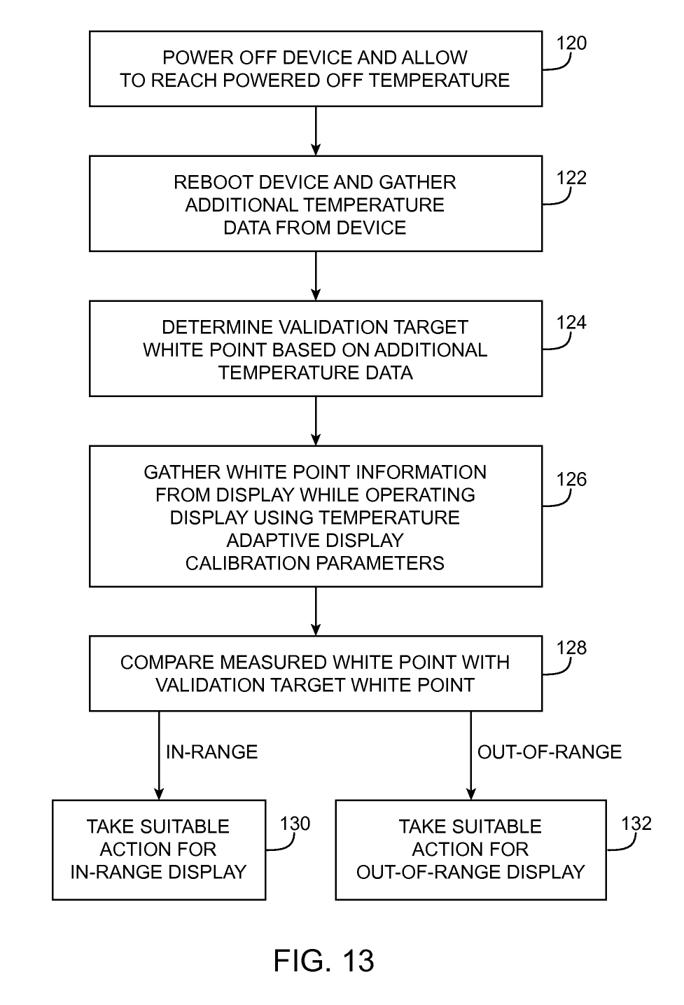

FIG. 13 is a flow chart of illustrative steps involved in performing validation operations to verify the color performance of display 14 (as described in step 102 of 10).

At step 120, device 10 may be powered off and allowed to reach a “powered off” temperature. For example, device 10 may be powered off and allowed to cool down to a stable temperature such as room temperature.

At step 122, device 10 may be powered on (e.g., rebooted) and calibration computing equipment 46 may be used to gather additional temperature data from device 10 using thermal sensor 60. Temperature data may be gathered during boot-up operations, one minute after boot-up operations, five minutes after boot-up operations, and/or at other suitable times. If desired, temperature data gathered during step 122 of validation operations may correspond to the same time at which temperature data was gathered during step 112 of calibration operations (e.g., one minute after boot-up operations).

At step 124, calibration computing equipment 46 may determine a validation target white point based on the additional temperature data gathered during step 122. This may include, for example, using equations (1) and (2) to re-determine a temperature adaptive target white point (xₜ, yₜ) based on the additional temperature data. The temperature adaptive target white point that is calculated during validation operations may sometimes be referred to as a validation target white point. If equations (1) and (2) are used to determine the validation target white point, T may be equal to the temperature reading obtained during step 122, and μₓ and μ_{y} may be based on the temperature dependence information gathered during step 110 of FIG. 11 (e.g., μₓ may be equal to the slope of line 66, and μ_{y} may be equal to the slope of line 64).

At step 126, calibration computing equipment 46 may gather white point information from display 14 while display 14 is operated using the temperature adaptive display calibration parameters which were provided to device 10 during calibration operations (FIG. 12). This may include measuring the white point of display 14 (e.g., the calibrated white point of display 14) using a light sensor such as light sensor 40 (FIG. 8). If desired, calibration computing equipment 46 may concurrently be provided with temperature data from sensor 60 (as described in step 122) and with white point information from light sensor 40 (step 126).

At step 128, calibration computing equipment 46 may compare the measured white point of display 14 (measured in step 126) with the validation target white point (determined in step 124). For example, calibration computing equipment 46 may determine if the measured white point of display 14 (e.g., the calibrated white point) is within a predetermined acceptable range of the validation target white point.

If it is determined in step 128 that the measured white point of display 14 is within the acceptable range of the validation target white point, then validation operations may proceed to step 130.

At step 130, appropriate action may be taken for an in-range display (e.g., for a “passing” display exhibiting acceptable color performance). Appropriate action for an in-range display may include terminating display calibration operations and shipping device 10 with the passing display to an end-user, passing device 10 with the passing display onto a subsequent calibration station or test station for calibrating or testing other components of device 10, or passing device 10 onto subsequent manufacturing stations for further assembly of device 10.

If it is determined in step 128 that the measured white point of display 14 is outside of the acceptable range of the validation target white point, then validation operations may proceed to step 132.

At step 132, appropriate action may be taken for an out-of-range display (e.g., for a display exhibiting less than acceptable color performance). Appropriate action for an out-of-range display may include repeating calibration operations. For example, calibration operations may return to step 116 of FIG. 12 and calibration computing equipment 46 may re-generate temperature adaptive calibration parameters for device 10. If desired, temperature adaptive calibration parameters which are re-generated for an out-of-range display may be based on the originally gathered temperature data from device 10 (step 112) or may be based on newly gathered temperature data from device 10.

In situations where calibration system 48 is unable to successfully calibrate a display, the display may be considered a failing display. Appropriate action for a failing display may include replacing the display, reworking the display, returning the display to a vendor, or otherwise disposing of a failing display.

The foregoing is merely illustrative of the principles of this invention and various modifications can be made by those skilled in the art without departing from the scope and spirit of the invention. The foregoing embodiments may be implemented individually or in any combination.

What is claimed is:

1. A method for calibrating a display in an electronic device using a calibration system that includes calibration computing equipment and a thermal sensor, comprising:
with the thermal sensor, gathering temperature data from the electronic device; and
with the calibration computing equipment, determining a temperature adaptive target white point for the display based on the temperature data.

2. The method defined in claim 1, further comprising:
with the calibration computing equipment, measuring a native white point of the display; and
with the calibration computing equipment, determining whether the native white point is within a predetermined range of the temperature adaptive target white point.

3. The method defined in claim 1, further comprising:
with the calibration computing equipment, generating display calibration parameters for the electronic device based on the temperature adaptive target white point.

4. The method defined in claim 3, further comprising:
with the calibration computing equipment, transferring the display calibration parameters to the electronic device.

5. The method defined in claim 4, further comprising:
with the thermal sensor, gathering additional temperature data from the electronic device; and
with the calibration computing equipment, determining a validation target white point using the additional temperature data.

6. The method defined in claim 5, further comprising:
with the calibration computing equipment, measuring a display white point of the display while the display is operated using the display calibration parameters.

7. The method defined in claim 6, further comprising:
with the calibration computing equipment, determining whether the display white point is within a predetermined range of the validation target white point.

8. The method defined in claim 1, wherein the electronic device comprises a display cover glass and wherein gathering the temperature data from the electronic device comprises:
with the thermal sensor, measuring a temperature of the display cover glass.

9. A method for calibrating a display in an electronic device using a calibration system that includes calibration computing equipment, comprising:
with the calibration computing equipment, gathering white point temperature dependence information from a plurality of additional electronic devices; and
with the calibration computing equipment, determining a temperature adaptive target white point for the display using the white point temperature dependence information.

10. The method defined in claim 9, wherein the calibration system comprises a thermal sensor and a light sensor and wherein gathering the white point temperature dependence information from the plurality of additional electronic devices comprises:
for each electronic device in the plurality of additional electronic devices, gathering temperature data using the thermal sensor; and
for each electronic device in the plurality of additional electronic devices, gathering native white point information using the light sensor.

11. The method defined in claim 10, further comprising:
with the calibration computing equipment, extracting a relationship between display white point and temperature using the native white point information and the temperature data gathered from the plurality of additional electronic devices.

12. The method defined in claim 11, wherein extracting the relationship between display white point and temperature comprises:
with the calibration computing equipment, determining an amount by which a chromaticity value changes for a given change in temperature.

13. The method defined in claim 9, wherein the calibration system comprises a thermal sensor, the method further comprising:
with the thermal sensor, gathering temperature data from the electronic device.

14. The method defined in claim 13, wherein determining the temperature adaptive target white point for the display comprises:
using the temperature data in combination with the white point temperature dependence information to determine the temperature adaptive target white point for the display.

15. The method defined in claim 13, wherein the display comprises a backlight and wherein gathering the temperature data comprises:
with the thermal sensor, measuring a temperature of the backlight.

16. The method defined in claim 9, further comprising:
with the calibration computing equipment, gathering native white point information from the display; and
with the calibration computing equipment, comparing the native white point information with the temperature adaptive target white point.

17. The method defined in claim 16, further comprising:
with the calibration computing equipment, generating display calibration parameters based on the comparison of the native white point information with the temperature adaptive target white point; and
with the calibration computing equipment, providing the display calibration parameters to the electronic device.

18. An electronic device, comprising:
a display having an array of display pixels;
storage and processing circuitry configured to store temperature adaptive display calibration parameters; and
display control circuitry configured to provide display control signals to the display using the temperature adaptive display calibration parameters.

19. The electronic device defined in claim 18, wherein the display comprises a liquid crystal display and wherein the temperature adaptive display calibration parameters are based on a temperature adaptive target white point.

20. The electronic device defined in claim 19, wherein the electronic device comprises a thermal sensor and wherein the temperature adaptive target white point is based on data gathered using the thermal sensor.

21. The electronic device defined in claim 18, wherein the temperature adaptive display calibration parameters comprise at least one factor configured to adjust an intensity of light to be displayed by at least one display pixel in the array of display pixels.
